(19) United States
(12) Patent Application Publication
(10) Pub. No.: US 2009/0228808 A1
(43) Pub. Date: Sep. 10, 2009

(54) Web Conferencing

(75) Inventors: Michael A. MacDonald, Rockville, MD (US); Robert Greifeld, Rockville, MD (US); Chris Concannon, Rockville, MD (US)

Correspondence Address: FISH & RICHARDSON PC, P.O. BOX 1022, MINNEAPOLIS, MN, 55440-1022, US

(73) Assignee: THE NASDAQ OMX GROUP, INC., Rockville, MD (US)

(21) Appl. No.: 12/042,539

(22) Filed: Mar. 5, 2008

(51) Int. Cl. G06F 3/048; G06F 15/16

(52) U.S. Cl. 715/756

(57) ABSTRACT

Techniques are described for initiating a video conferencing and a desktop sharing session are described. The techniques include sending an invitation to participants of the video conferencing and a desktop sharing session and communicating market information among participants of the video conferencing and desktop sharing session.

### BACKGROUND

This invention relates to electronic securities trading, and the processing and displaying of information relating to electronic securities trading.

Electronic equity markets, such as The NASDAQ Stock Market, collect, aggregate, and display pre-trade and post-trade information so that market participants can proactively monitor intraday market conditions and activity. In the NASDAQ Stock Market, for example, this pre-trade information takes the form of a quote that represents a single or an aggregate of same-priced principal or agency orders. A market, such as The NASDAQ Stock Market, also provides trading platforms through which market participants may trade and monitor securities in the marketplace.

### SUMMARY

In accordance with an aspect of the invention, a computer-implemented data presentation method includes initiating a video conferencing and a desktop sharing session using a communications network, sending an invitation to participants of the video conferencing and a desktop sharing session and communicating market information among participants of the video conferencing and desktop sharing session.

The following embodiments are within the scope of this aspect of the invention. The method includes communicating real-time market information. Initiating a session includes viewing an issuer account, accessing a website, and adding contacts to the invitation. Sending an invitation includes calling an application programming interface, providing a unique meeting identification number, and providing, for each user, a link and a password. The session is conducted at a scheduled time. The session is conducted at a non-scheduled time. The invitation is sent in email. The invitation is sent through a link provided in an investor relations tool. The session comprises a video module. The session comprises a NASDAQ Market Intelligence Desk module. The session comprises a chat panel module.

In accordance with an additional aspect of the invention, a computer program product resides on a computer readable medium. The computer program product is for initiating a video conferencing and a desktop sharing session using a communications network, sending an invitation to participants of the video conferencing and a desktop sharing session, and communicating market information among participants of the video conferencing and desktop sharing session.

The following embodiments are within the scope of this aspect of the invention. The computer program product also includes communicating a real-time market information. Initiating a session includes viewing an issuer account, accessing a website, and adding contacts to the invitation. Sending an invitation includes calling an application programming interface, providing a unique meeting identification number, and providing, for each user, a link and a password.

One or more aspects of the invention may provide one or more of the following advantages. A method is presented that permits participants to discuss complex or especially “visual” data, such as charts, related to market information via a video conferencing and desktop sharing session. The method further provides for many participants to collaborate and to discuss the complex or visual data from different view-points.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram showing users accessing a video conference and desktop sharing session.

FIG. 2 is a block diagram showing establishing a session.

FIG. 3A is an image of an exemplary email containing a link to a video conference.

FIG. 3B is an image of an investor relations tool having a link to a video conference.

FIG. 4 is an image of a welcome screen for a video conference.

FIG. 5 is a screenshot showing an exemplary graphical user interface for a video conference.

### DETAILED DESCRIPTION

A software application can be used to collect and to distill market and trading information. One such program is the Market Intelligence Desk (MID), a NASDAQ OMX program that provides real-time monitoring to help issuers track their company's stock minute-by-minute and includes a team of professionals from a variety of market backgrounds (e.g., sell-side trading, buy-side trading, electronic markets, auction markets, equity research, portfolio management, and investment banking).

Exchanges and markets can provide certification programs for traders that “provide” or “make” markets in securities or otherwise furnish capital. For example, one such certification program is the Select Market Maker (SMM) Program that recognizes market makers whose quality of quoting and execution services in NASDAQ-listed securities have been evaluated by NASDAQ. For example, a market maker can be designated as “select” based on a previous month's performance on a stock-by-stock basis. To qualify for “select” designation, a firm must be a registered market maker in the given stock. The Select Market Maker designation can be based on various parameters, such as a market maker's quote relative to a National Best Bid or Offer (NBBO), a time a market maker is quoting relatively close to a NBBO, or a market maker's market share.

A liquidity provider, defined as a market participant whose quote or order is accessed via NASDAQ, can give NASDAQ OMX-listed companies additional information about trading activity, particularly in conjunction with specific events (e.g., heavy trading days, persistent trends, big blocks, earnings releases). The MID serves as a central contact point for NASDAQ-listed companies and can provide further trading insight for those companies from their Select Market Makers. For example, the MID can serve as a conduit between Select Market Makers and listed companies by facilitating timely conversations in conjunction with specific events (e.g., heavy trading days, persistent trends, big blocks, earnings releases).

Other programs are possible. Exchanges and markets, may provide investor relations tools. One such tool is the NASDAQ Online (NOL) program, which aggregates financial data from many different suppliers into a convenient form for executives of NASDAQ-issuing corporations. NASDAQ Online has about 10,000 users, including CEOs, CFOs and IR executives of NASDAQ's 3,100 listed companies.

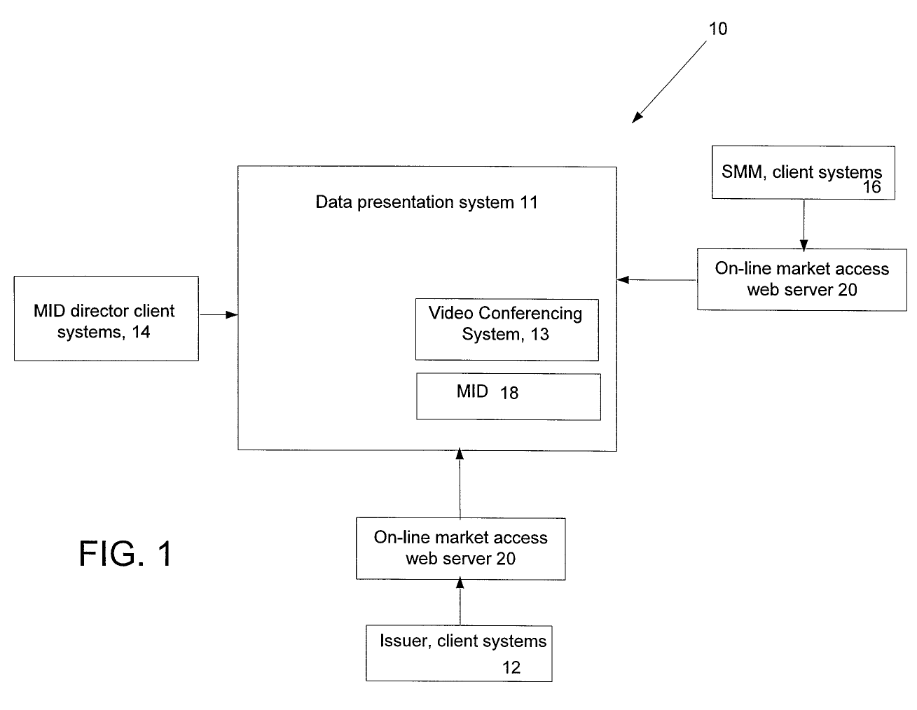

Referring to FIG. 1, a data presentation system 11 is shown that allows a user (e.g., a Market Intelligence Desk director) to conduct a video conferencing and a desktop sharing (VCDS) session 10 with other parties (e.g., an issuer, a Select Market Maker) to communicate market information (e.g., data or charts about stock trading) among the parties.

Each participant (e.g., an issuer, an MID director, an SMM) can access the VCDS session 10 using his own computer and can be connected to other participants using, for example, the internet. In some embodiments, the VCDS session 10 can be a downloaded application on each participant's computer. In some embodiments, the VCDS session 10 can be a web-based application that participants can access (e.g., by viewing a “URL” or a website meeting address). For example, the initiating user (e.g., a Market Intelligence Desk director) can access the system 11 by using a MID director client systems 14. A non-initiating user (e.g., the issuer, the SMM) can access the VCDS session 10 by using an on-line market access web server 20 (e.g., NOL).

A VCDS session 10 can be conducted using the system 11 that enables the MID environment 18 to interact with an on-demand collaboration, online meeting, web conferencing, video conferencing system 13 (e.g., WebTrain Communicator™, Genesys Meeting Center®, Adobe Acrobat Connect™, Lotus Sametime® Connect™, Microsoft® LiveMeeting, Microsoft® Net Meeting, WebEx™) as well as other applications.

A presenter can speak over a standard telephone line or a voice over internet protocol (VoIP), explaining information (e.g., a stock chart, a spreadsheet) as it is displayed on a screen. A participant can respond using a telephone or a VoIP. Other typical features of a VCDS session can include a slide presentation (e.g., using slides generated by PowerPoint or Adobe), a live video (e.g., using a webcam or a digital video camera), a recording feature for viewing displayed materials at a later time, a whiteboard that provides the presenter and/or attendees to highlight or mark items on a slide presentation or to make notes on a blank whiteboard, a text-based chat feature for live question and answer sessions, a poll or a survey to convey questions from a presenter to a participant, among others.

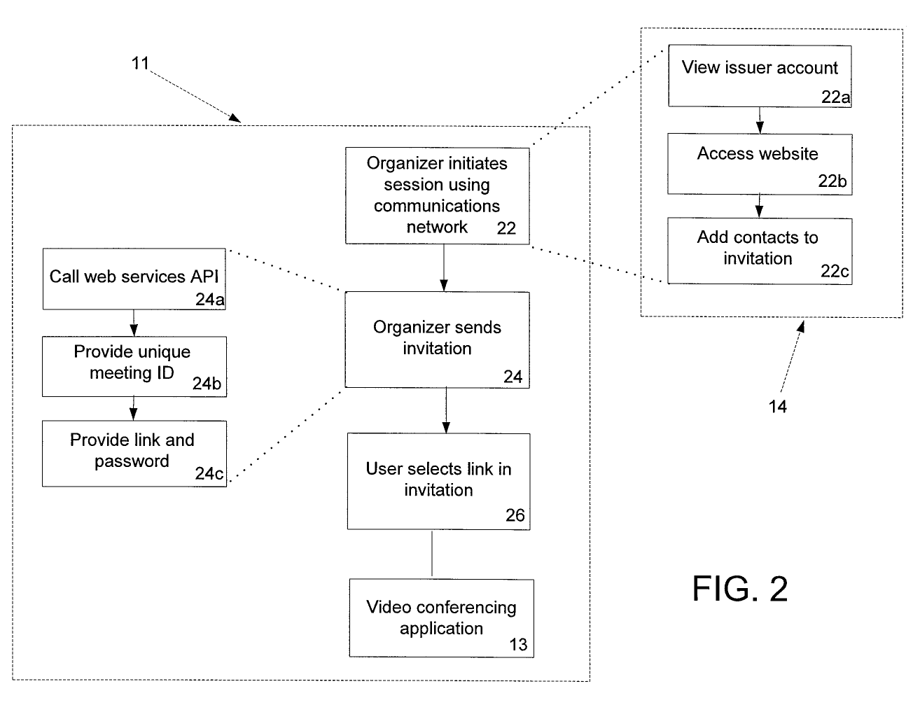

Referring to FIG. 2, an organizer (e.g., the MID director) can initiate 22 a VCDS session 10, for example, when discussing complex or especially “visual” data, such as charts, with a user (e.g., the issuer). While viewing 22a a specific account of a specific listed entity, for example, “Cisco”, the organizer can access 22b a website that displays a list of all active “Cisco” contacts and their email addresses as stored in a customer relationship management software. The organizer accesses the website from the MID environment 18. Each contact, when selected, can be added 22c to an invitation to participate in a video conferencing and a desktop sharing session. In some embodiments, the session organizer can manually add other participants, such as the Select Market Maker. Also, the session organizer can be added automatically to the session.

In some embodiments, once all participants are identified, the session organizer begins a program (e.g., a WebEx™ application programming interface (API)) to send 24 an email invitation to all each participants. Email invitations are sent directly to parties or are sent as a “blind carbon copy.” A sender's email address can be a generic MID email address.

An invitation is generated when an application in the MID environment 18 calls 24a an API. When called, API can provide 24b a unique meeting identification number that will be embedded in invitation link sent to participants. The link can be a request message written in hypertext transfer protocol (HTTP) and can include a request message from a client to a server. For example, the request message can include the method to be applied to a resource, an identifier of the resource, and a protocol version in use. The method can be a “GET” method; the identifier of the resource can be a uniform resource locator (URL) that will include a meeting identification number, a URL-encoded function/link, and a random 8-character password, which can be generated. The API can provide 24c a link and a password. Other arrangements are possible. The user can select 26 the link in the invitation.

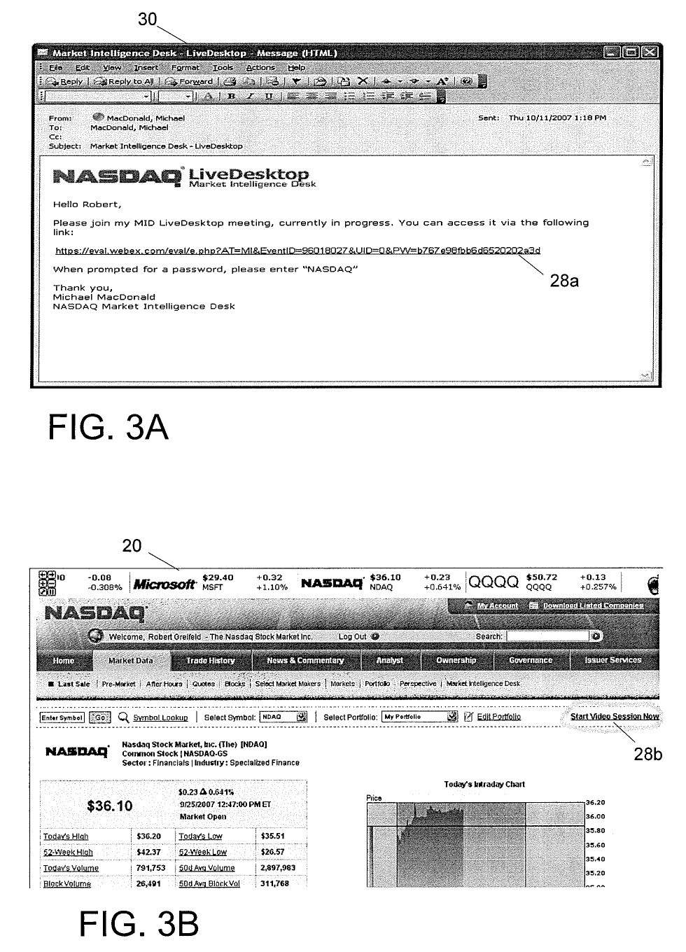

Referring to FIG. 3A, a user accesses the video conferencing and the desktop sharing session by following a website link 28a embedded in an email message 30.

Alternatively, a meeting organizer (e.g., the MID director) can send a meeting invitation link to the on-line market access web server 20 for a user (e.g., an issuer) who has selected a “click-to-call” button in the web environment. Once selected, a user begins a discussion with the MID director. If appropriate, the MID director invites the user to begin a session by selecting a link on the MID environment 18. This action adds content, e.g., a link, to the session record of the user in a database within the web server 20. Polling logic within the web server 20 checks the session record at predetermined intervals (e.g., 1 second, 5 seconds, 15 seconds). If a link is found in the appropriate field, the link is dynamically displayed to the user.

As shown in FIG. 3B, a user (e.g., the issuer) can access the VCDS session 10 by selecting a link 28b displayed in the environment provided by the access web server 20.

After the user selects, for example, the link 28a or the link 28b, a session screen can appear.

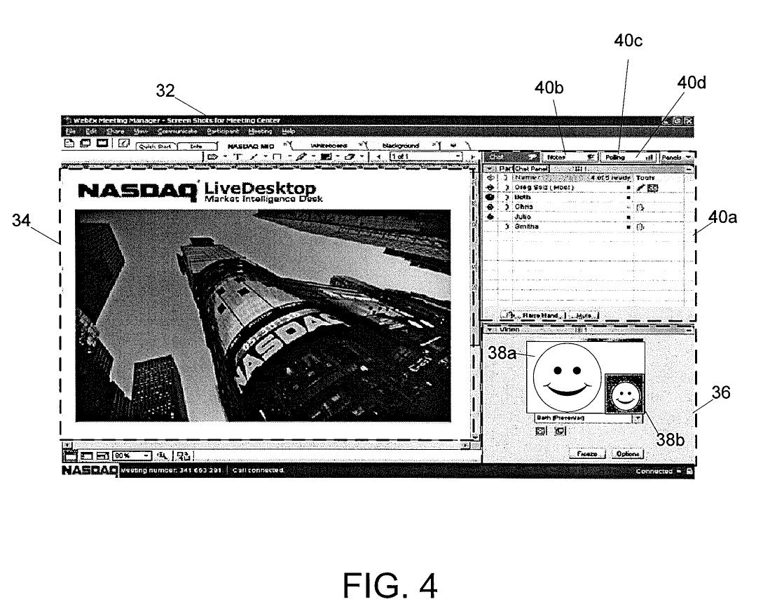

Referring to FIG. 4, a session screen 32 can provide, in a sub-display, a welcome screen 34. In another sub-display of screen 32, a video module 36 can display a first presenter in a larger window 38a and a second presenter in a smaller window 38b. In FIG. 4, a smiley face is used as a proxy for the first and second presenters. In practice, these images will be representative of the persons (e.g., a MID director, a SMM) who are participating in the video conferencing and desktop sharing session. Window 38b can be displayed within window 36a, as shown, or separate from window 36a. For example, the first presenter could be the MID director and the second presenter could be the SMM. In some embodiments, additional users, such as issuers, could also contribute a video stream to the video conference. Video conference participants can be listed in a chat panel module 40a. Additional tabs (e.g., notes 40b, polling 40c, panels 40d) can perform similar functions as corresponding tabs in standard video conferencing programs.

In some embodiments, the on-demand collaboration VCDS session 10 provides the market or exchange with access to an API through which the market or exchange dynamically produces and terminates meetings and meeting identification numbers. The on-demand collaboration VCDS system 10 enables users of the market or exchange to have “one-click access” to meetings, without requiring any additional user input. The on-demand collaboration VCDS system 10 enables users of the market or exchange to exit meetings without displaying any content or exit pages, and can produce a custom page that is displayed to users when a session organizer (e.g., an MID Director) is not yet present in the meeting. The on-demand collaboration VCDS system 10 can embed a market or exchange logo in the session screen 32. In some embodiments, a custom welcome page can be displayed to users upon entry into a new session. In addition, custom pages for all other screens can be displayed to the market or exchange users.

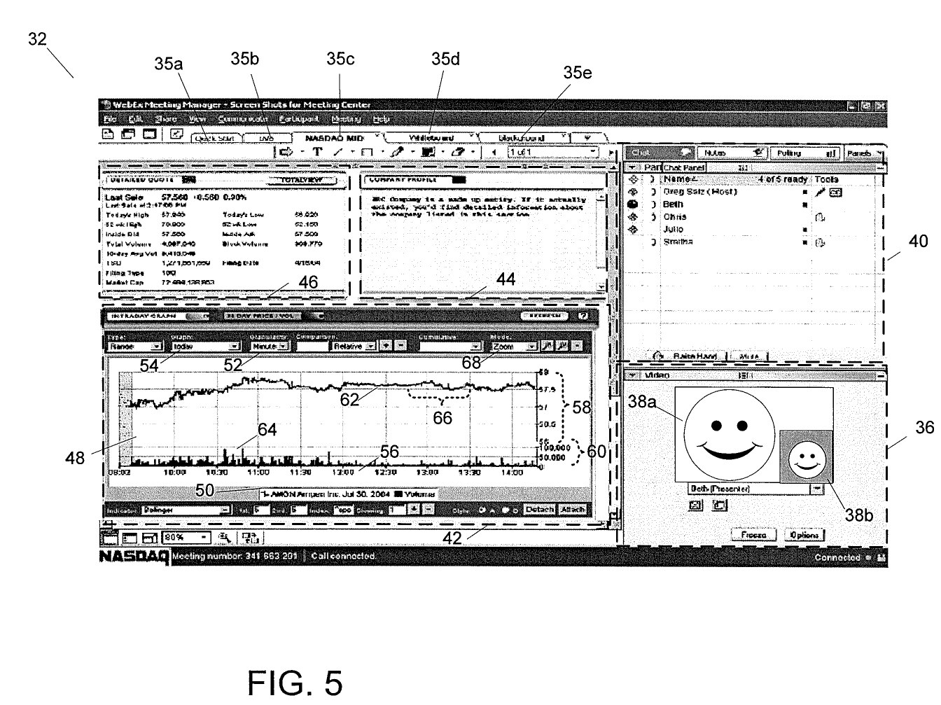

Referring to FIG. 5, a session screen 32 is shown, provided by the data presentation system 11, that allows the user to conduct a VCDS session 10 with other parties (e.g., the MID director, the SMM). An MID tab 35c displays the video module 36; another sub-region of screen 32 lists video conference participants in the chat panel module 40.

The session screen 32 also allows the display of various types of chronological trade data. The first or second presenter may describe any portion of this trade data in greater detail. The MID tab 35c typically includes three additional modules: a chart module 42, a company profile module 44, and a detailed quote module 46. An info tab 35b can serve as a welcome screen (e.g., welcome screen 34). A whiteboard tab 35d can provide a presenter a module in which to display visual information (e.g., a chart, an image). Other tabs (e.g., quick start tab 35a, “blackground” tab 35e) can perform similar functions as the corresponding tabs in standard video conferencing programs.

The data typically relates to an issue available for trade on a computerized trading system. In the chart module 42, the issuer can select various parameters that define and configure a chart 48 generated from chronological trade data. The issuer can select the issue from a scrollable list. This menu can list ticker symbols or can list the full name of the issue. Alternatively, the issuer can enter the issue's ticker symbol directly, for example, in a field 50 of the chart 48.

The user can also select a time granularity of chart 48 from choices displayed in a scrollable list 52. The time granularity (e.g., seconds, minutes, hours) defines the resolution displayed on the abscissa of the chart 48.

Additionally, the issuer can select which trading day is graphed in chart 48 from a list 54. When the chart 48 is generated, a time line 56 is displayed that encompasses portions of the trading day (e.g., from 9:30 a.m. until 4:00 p.m., from 8:02 a.m. until 2:30 p.m.) or the entire trading day.

Examples of the type of trade data that can be displayed in the chart 48 are trade price data 58 and trade volume data 60. The chart 48 can include a chronological line chart 62 (i.e., the portion of the chart that specifies the trade price data 58) and a chronological bar chart 64 (i.e., the portion of the chart that specifies the trade volume data 60).

The issuer can magnify or reduce a specific portion of time line 56 by selecting a portion 66 of the time line while the “zoom” mode is selected from menu 68. Once the appropriate portion is selected, display module redraws the chart 48 to display only the selected portion 66 of the time line 56.

The company profile module 44 can list detailed information (e.g., size, management, contact information) about the company.

The detailed quote module 46 lists detailed information about an issue. For example, the information can include a last sale price, a last sale time, a high sale price, a 52-week high sale price, an inside bid price, a total trade volume, a 10-day average trade volume, a total of shares outstanding, a filing type, a market capitalization, a low sale price, a 52-week low sale price, an inside ask price, a block trade volume, and/or a filing date.

In some embodiments, while the first or second presenter explains the trade data to the issuer 12, the issuer performs a screen capture and pastes this information from the screen capture into a separate application.

Upon completion of the video conference, the first presenter, the second presenter, and any users exit the session screen 32.

Open meeting identification numbers are periodically deleted, (e.g., every 24 hours) to prevent reuse. This deletion can be accomplished at specified intervals by calling an API and deleting each meeting identification number.

The data presentation system typically resides on and is executed by a computer system that may be connected to a network (e.g., the Internet, an intranet, a local area network, or some other form of network). The instruction sets and subroutines of the data presentation system are typically stored on a storage device connected to the computer system. The storage device may be, for example, a hard disk drive, a tape drive, an optical drive, a RAID array, random access memory (RAM), dynamic RAM (DRAM), static RAM (SRAM), etc. A user typically accesses, administers, and uses the data presentation system through a desktop application (e.g., Microsoft® Internet Explorer@, Mozilla Firefox®, a specialized user interface) running on a computer system that is also connected to the network.

Implementation of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer readable medium for execution by or to control the operation of a data processing apparatus.

The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to a suitable receiver apparatus.

A computer program (often referred to as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical, or optical disks. However, a computer need not have such devices.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented data presentation method, the method comprising:
initiating a video conferencing and a desktop sharing session using a communications network;
sending an invitation to participants of the video conferencing and a desktop sharing session; and
communicating market information among participants of the video conferencing and desktop sharing session.

2. The method of claim 1, further comprising communicating real-time market information.

3. The method of claim 1, wherein initiating a session comprises:
viewing an issuer account;
accessing a website; and
adding contacts to the invitation.

4. The method of claim 1, wherein sending an invitation comprises:
calling an application programming interface;
providing a unique meeting identification number; and
providing, for each user, a link and a password.

5. The method of claim 1, wherein the session is conducted at a scheduled time.

6. The method of claim 1, wherein the session is conducted at a non-scheduled time.

7. The method of claim 1, wherein the invitation is sent in email.

8. The method of claim 1, wherein the invitation is sent through a link provided in an investor relations tool.

9. The method of claim 1, wherein the session comprises a video module.

10. The method of claim 1, wherein the session comprises a NASDAQ Market Intelligence Desk module.

11. The method of claim 1, wherein the session comprises a chat panel module.

12. A computer program, encoded on a computer-readable medium, operable to cause a data processing apparatus to perform operations comprising:
initiating a video conferencing and a desktop sharing session using a communications network;
sending an invitation to participants of the video conferencing and a desktop sharing session; and
communicating a market information among participants of the video conferencing and desktop sharing session.

13. The computer program product of claim 12, further comprising communicating real-time market information.

14. The computer program product of claim 12, wherein initiating a session comprises:
viewing an issuer account;
accessing a website;
and adding contacts to the invitation.

15. The computer program product of claim 12, wherein sending an invitation comprises:
calling an application programming interface;
providing a unique meeting identification number; and
producing, for each user, a link and a password.
